(19) United States
(12) Patent Application Publication
(10) Pub. No.: US 2022/0171788 A1
(43) Pub. Date: Jun. 2, 2022

(54) DATA SYNCHRONIZATION SYSTEM, DATA SYNCHRONIZATION APPARATUS, AND DATA SYNCHRONIZATION METHOD

(71) Applicant: Hitachi, Ltd., Tokyo (JP)

(72) Inventors: Daisuke ITO, Tokyo (JP); Shinichiro SAITO, Tokyo (JP)

(73) Assignee: Hitachi, Ltd., Tokyo (JP)

(21) Appl. No.: 17/539,383

(22) Filed: Dec. 1, 2021

(30) Foreign Application Priority Data
Dec. 2, 2020 (JP) 2020-200535

(51) Int. Cl. G06F 16/27; G06F 16/174; G06F 16/22; G06F 9/48

(52) U.S. Cl. CPC G06F 16/27; G06F 9/4881; G06F 16/2255; G06F 16/1756

(57) ABSTRACT

This invention is intended to process data synchronization more efficiently. Disclosed is a data synchronization system comprising: an all records fetching unit that fetches all records of synchronization target data, i.e., data specified as a target of synchronization, from a first device that is a source of synchronization; one or more storage units to prestore synchronization destination data, namely, data that is now retained on a second device that is a destination of synchronization and store synchronization target data fetched by the all records fetching unit; and a difference extraction unit that identifies difference to be reflected in the data on the second device by using the synchronization destination data and the synchronization target data, makes identified difference reflected in the data on the second device, and, after the reflection, updates the synchronization destination data based on the synchronization target data.

### BACKGROUND

The present invention relates to a data synchronization system, a data synchronization apparatus, and a data synchronization method.

A related art technique for data synchronization between multiple devices is found in Japanese Unexamined Patent Application Publication No. 2011-232866. In this publication, there is a description of “a data migration method between database devices for migrating data on a first database device to a second database device, arranged by comprising: acquiring snapshot data of the data on the first database device and snapshot data of the corresponding data on the second database device, extracting difference between these snapshots data as synchronization data based on the snapshot data of the data on the first database device and the snapshot data of the corresponding data on the second database device, and writing the difference as synchronization data to the second database device”.

### SUMMARY

As in the related art typified by the technique described in Japanese Unexamined Patent Application Publication No. 2011-232866, by extracting and writing the difference as synchronization data to the synchronization sink device (the second database device in the above-mentioned publication), the load of the synchronization sink device can be reduced. For this manner of data synchronization, it is desirable that, inter alia, extracting difference as synchronization data is performed outside of the synchronization sink device so as to achieve a more efficient way of data synchronization. To enhance the efficiency, it is also desired to shorten the amount of time when the synchronization source device is engaged in data synchronization processing.

Therefore, it is an object of the present invention to process data synchronization more efficiently.

In order to attain the foregoing object and in accordance with one representative aspect of the invention, a data synchronization system and a data synchronization apparatus each comprise the following: an all records fetching unit that fetches all records of synchronization target data, i.e., data specified as a target of synchronization, from a first device that is a source of synchronization; one or more storage units to prestore synchronization destination data, namely, data that is now retained on a second device that is a destination of synchronization and store synchronization target data fetched by the all records fetching unit; and a difference extraction unit that identifies difference to be reflected in the data on the second device by using the synchronization destination data and the synchronization target data, makes identified difference reflected in the data on the second device, and, after the reflection, updates the synchronization destination data based on the synchronization target data.

According to another representative aspect of the invention, a data synchronization method comprises the steps of: fetching all records of synchronization target data, i.e., data specified as a target of synchronization, from a first device that is a source of synchronization; storing synchronization target data fetched by the step of fetching all records into a certain storage unit; by using synchronization destination data, namely, data that is now retained on a second device that is a destination of synchronization and the synchronization target data, identifying difference to be reflected in the data on the second device; making identified difference reflected in the data on the second device; and, after the reflection, updating the synchronization destination data based on the synchronization target data.

According to the present invention, it is possible to process data synchronization more efficiently. Problems, configurations, and advantageous effects other than noted above will be made apparent from the following description of embodiments.

### BRIEF DESCRIPTION OF THE DRAWINGS

FIG. 1 is a system structural diagram of a first embodiment.

FIG. 2 is a functional structural diagram of a data transfer device.

FIG. 3 is a diagram to explain a synchronization processing procedure.

FIG. 4 is a flowchart illustrating a processing procedure of a process of fetching all records by an all records fetching module.

FIG. 5 is a flowchart illustrating a processing procedure of a process of extracting difference by a difference extraction module.

FIG. 6 is a structural diagram of the data transfer device.

FIG. 7 is a flowchart illustrating a processing procedure of the process of extracting difference in a second embodiment.

FIG. 8 is a diagram to explain previous data in the second embodiment.

FIG. 9 is a flowchart illustrating a processing procedure of the process of extracting difference in a third embodiment.

FIG. 10 is a diagram to explain previous data in the third embodiment.

FIG. 11 is a flowchart illustrating a processing procedure of the process of extracting difference in a fourth embodiment.

FIG. 12 is a structural diagram of the data transfer device in the fourth embodiment.

FIG. 13 is a diagram to explain chunk size management.

FIG. 14 is a flowchart illustrating a processing procedure of the process of extracting difference in a fifth embodiment.

FIG. 15 is a diagram to explain chunk size management in the fifth embodiment.

FIG. 16 is a configuration example where multiple devices are used to cooperate to implement functionality of the data transfer device.

FIG. 17 is a concrete example of a synchronization setup screen.

### DETAILED DESCRIPTION

Embodiments of the invention are described below with the aid of drawings.

### First Embodiment

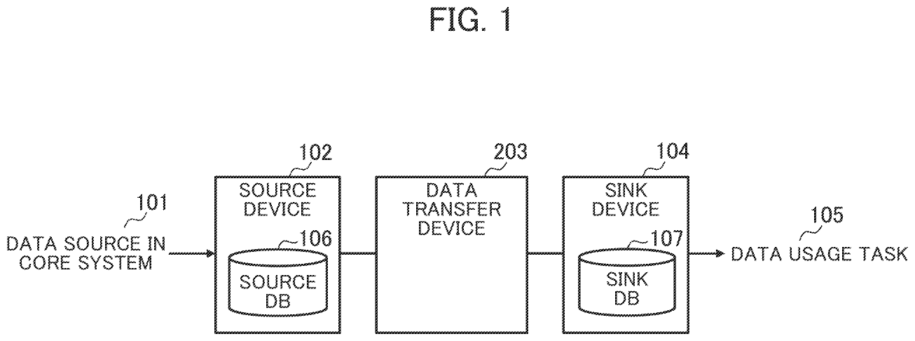

FIG. 1 is a system structural diagram of a first embodiment. A source device 102 depicted in FIG. 1 accumulates data from a data source in a core system into a source DB (database) 106. The source device 102 is connected via a data transfer device 203 to a sink device 104. A sink DB 107 in the sink device 104 is to be synchronized to the source DB 106. The sink DB 107 data is provided to a data usage task 15 such as data analysis.

In other words, the source device 102 is a first device acting as a source of synchronization and the sink device 104 is a second device acting as a destination of synchronization. Data transfer for synchronization from the source device 102 to the sink device 104 is performed by a data transfer device 203.

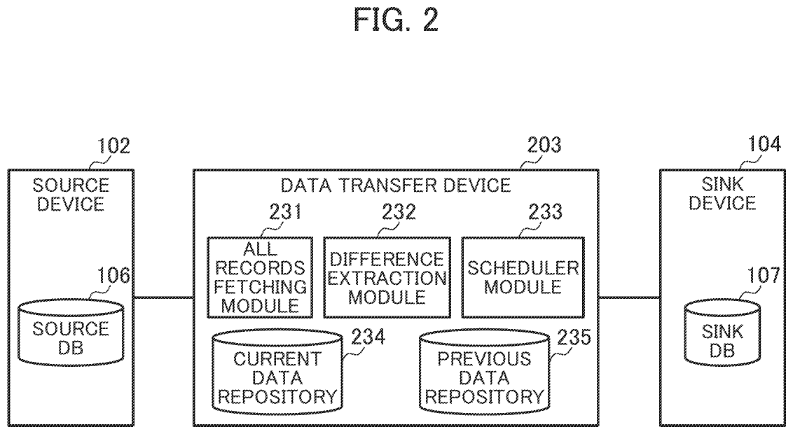

FIG. 2 is a functional structural diagram of the data transfer device 203. As is depicted in FIG. 2, the data transfer device 203 includes an all records fetching module 231, a difference extraction module 232, a scheduler module 233, and a current data repository 234, and a previous data repository 235.

The current data repository 234 is a storage repository to store synchronization target data specified as a target of synchronization for current synchronization processing. The synchronization target data is hereinafter referred to as current data. The previous data repository 235 is a storage repository to store synchronization destination data, namely, data that is now retained on the second device that is the destination of synchronization. The synchronization destination data is hereinafter referred to as previous data.

The all records fetching module 231 is an all records fetching unit that fetches all records of current data from the source device 102. The all records fetching module 231 stores fetched current data into the current data repository 234.

The difference extraction module 232 identifies difference to be reflected in the data on the sink device 104 by using previous data prestored in the previous data repository 235 and current data newly stored in the current data repository 234 by the all records fetching module 231. The difference extraction module 232 make identified difference reflected in the data on the sink device 104 and then updates the previous data to the current data. In other words, the difference extraction module 232 operates as a difference extraction unit that is mentioned in the claims hereof.

The scheduler module 233 is a functional unit that manages execution of data synchronization. The scheduler module 233 is capable of setting timing to execute data synchronization and setting a data table to be a target of data synchronization and starts data synchronization according to settings.

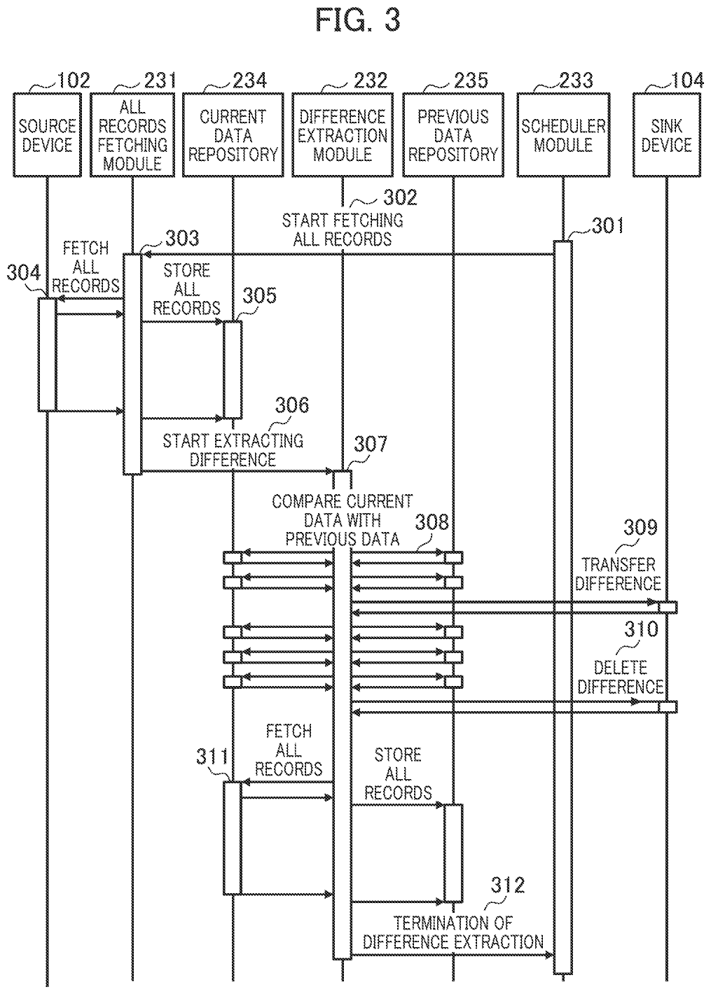

FIG. 3 is a diagram to explain a synchronization processing procedure. As is illustrated in FIG. 3, the scheduler module 233 first starts synchronization processing 301 at set timing. Upon starting the synchronization processing 301, the scheduler module 233 sends the all records fetching module 231 a command to start fetching all records (302).

Upon receiving the command from scheduler module 233, the all records fetching module 231 starts a process of fetching all records 303. Upon having started the process of fetching all records 303, the all records fetching module 231 sends a query to the source device 102 and receives a result of the query, thereby fetching all records of current data from the source device 102. An amount of time when the source device 102 is engaged in the synchronization processing corresponds to an aggregate of the execution time of a read process 304 from receiving a query until returning the query result.

The all records fetching module 231 stores all records of current data fetched from the source device 102 into the current data repository 234 (305). After that, the all records fetching module 231 sends the difference extraction module 232 a command to start extracting difference (306).

Upon receiving the command from the all records fetching module 231, the difference extraction module 232 starts a process of extracting difference 307. Upon having started the process of extracting difference 307, the difference extraction module 232 reads previous data from the previous data repository 235, compares the current data with the previous data, and identifies difference (308). The difference extraction module 232 makes the difference reflected in the data on the sink device 14 as follows: if the identified difference is occurrence of create or update, the module transfers the difference to the sink device 104 (309); if the identified difference is deleted, the module deletes the difference from the data on the sink device 104 (310).

After reflecting the difference in the data on the sink device 104, the difference extraction module 232 reads all records of current data from the current data repository 234 (311) and stores all the read records of current data into the previous data repository 235 as new previous data, thereby updating the previous data (312). After that, the difference extraction module 232 notifies the scheduler module 233 of the termination of difference extraction (312). Upon being notified of the termination of difference extraction, the scheduler module 233 terminates the synchronization processing 301.

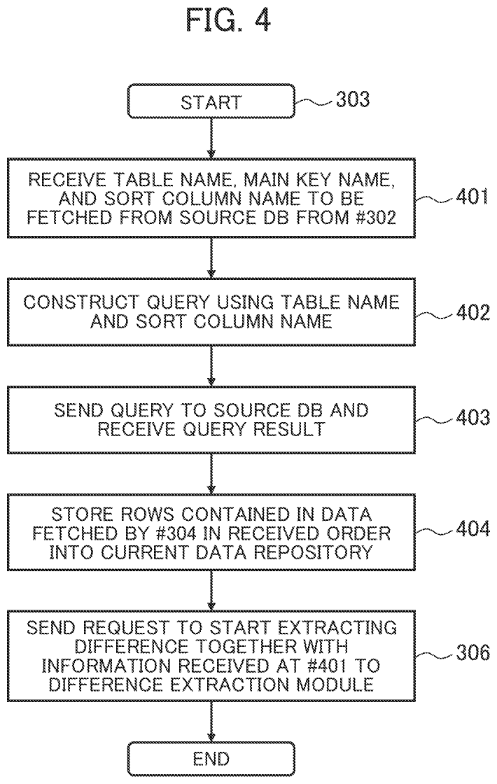

FIG. 4 is a flowchart illustrating a processing procedure of the process of fetching all records 303 by the all records fetching module 231. Upon starting the process of fetching all records 303, the all records fetching module 231 receives a table name, a main key, and a sort column name to be fetched from the source DB (401) from the command to start fetching all records (302).

The all records fetching module 231 constructs a query using the received table name and sort column name (402). After that, the all records fetching module 231 sends the query to the source DB 106 and receives the query result (403).

The all records fetching module 231 stores rows contained in the query result based on the read process (304) executed by the source device 102 in the received order into the current data repository 234 (404). After storing all rows contained in the query result, the all records fetching module 231 sends the difference extraction module 232 a request to start extracting difference together with information (table name, main key, and sort column name to be fetched from the source DB) received at 401 (306) and terminates the process of fetching all records.

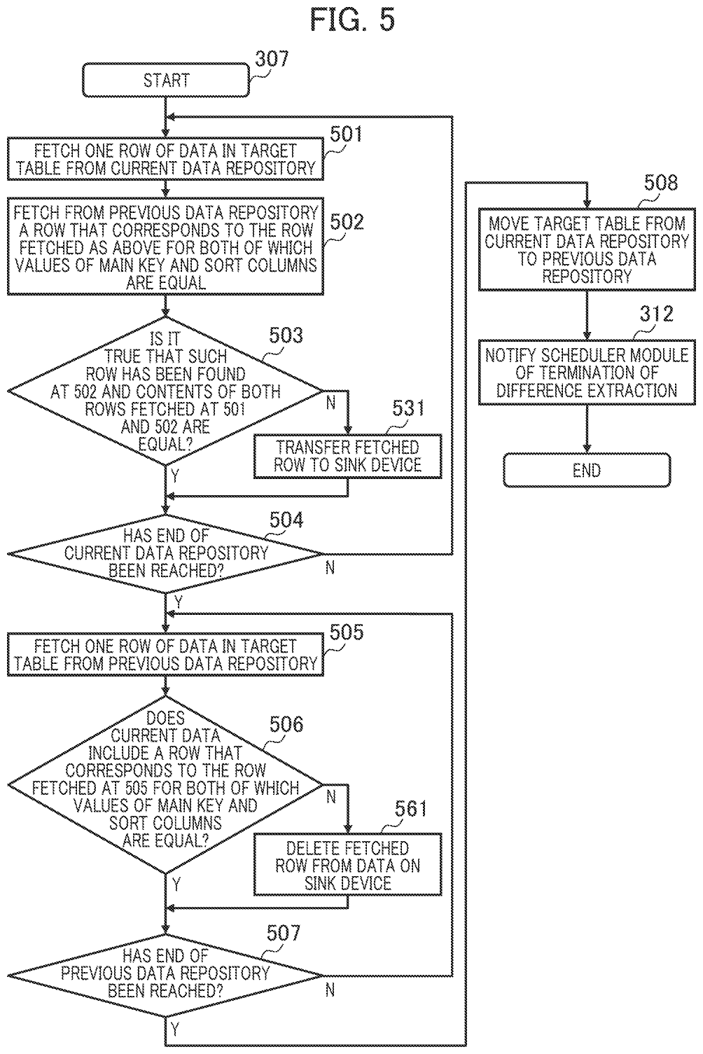

FIG. 5 is a flowchart illustrating a processing procedure of the process of extracting difference 307 by the difference extraction module 232. Upon starting the process of extracting difference 307, the difference extraction module 232 fetches one row of data in a target table from the current data repository 234 (501) and fetches from the previous data repository 235 a row that corresponds to the row fetched as above for both of which the values of main key and sort columns are equal (502).

If a row that corresponds to the row fetched at 501 for both of which the values of main key and sort columns are equal is found at step 502 of the processing and the contents of the row fetched at 501 and the row fetched at 502 are equal (503; Y), the difference extraction module 232 goes to a step 504 of the processing.

If a row that corresponds to the row fetched at 501 for both of which the values of main key and sort columns are equal is not found at step 502 of the processing or if the contents of the row fetched at 501 and the row fetched at 502 are not equal (503; N), the difference extraction module 232 transfers the row fetched at 501 to the sink device 104 (531) and then goes to a step 504 of the processing.

At the processing step 504, the difference extraction module 232 decides whether or not the end of the current data repository has been reached, i.e., whether or not all rows have now been fetched from the current data. If there remains at least an unfetched row (504; N), the difference extraction module 232 returns to the step 501 of the processing. If all rows have now been finished (504; Y), the difference extraction module 232 goes to a step 505 of the processing.

At the processing step 505, the difference extraction module 232 fetches one row in the target table from the previous data repository 235. After that, the difference extraction module 232 decides whether or not the current data includes a row that corresponds to the row fetched as above for both of which the values of main key and sort columns are equal (506).

At the processing step 506, if the current data includes a row that corresponds to the row fetched as above for both of which the values of main key and sort columns are equal, the difference extraction module 232 goes to a step 507 of the processing.

At the processing step 506, if the current data does not include a row that corresponds to the row fetched as above for both of which the values of main key and sort columns are equal, the difference extraction module 232 deletes the row fetched at 505 from the data on the sink device 104 (561) and then goes to the step 507 of the processing.

At the processing step 507, the difference extraction module 232 decides whether or not the end of the previous data repository has been reached, i.e., whether or not all rows have now been fetched from the previous data. If there remains at least an unfetched row (507; N), the difference extraction module 232 returns to the step 505 of the processing. If all rows have now been finished (507; Y), the difference extraction module 232 goes to a step 508 of the processing.

At the processing step 508, the difference extraction module 232 moves the target table from the current data repository 234 to the previous data repository 235. After that, the difference extraction module 232 notifies the scheduler module 233 of the termination of difference extraction (312) and terminates the process of extracting difference 307.

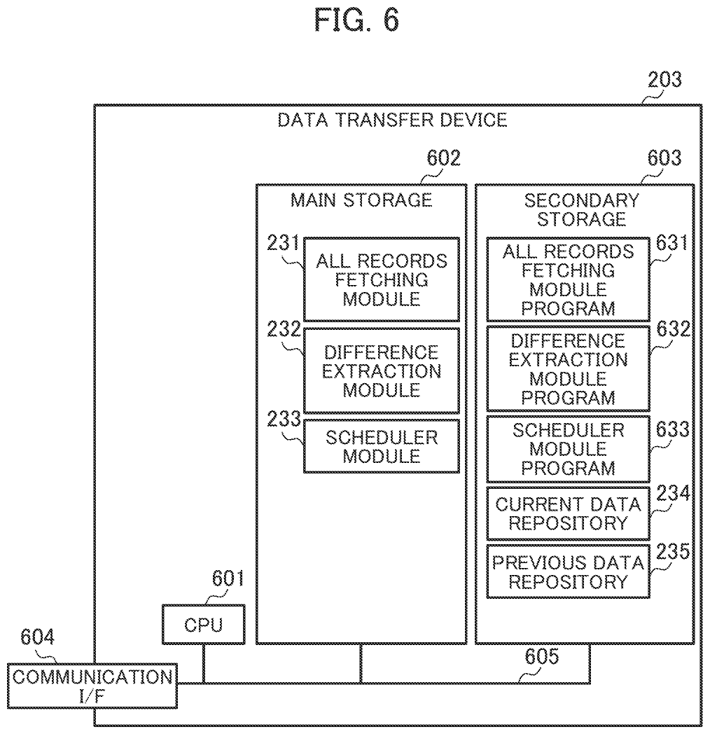

FIG. 6 is a structural diagram of the data transfer device 203. As is depicted in FIG. 6, the data transfer device 203 is a computer having a structure such that a CPU (Central Processing Unit) 601, a main storage 602, a secondary storage 603, and a communication interface 604 are interconnected by a bus 605.

The secondary storage 603 is a magnetic storage device or the like and stores an all records fetching module program 631, a difference extraction module program 632, and a scheduler module program 633. The secondary storage 603 also includes the current data repository 234 and the previous data repository 235. In other words, the secondary storage corresponds to a storage unit that is mentioned in the claims hereof.

The CPU 601 implements functionality as the all records fetching module 231 by reading the all records fetching module program 631 from the secondary storage 603, loading the program into the main storage 602, and executing the program. Likewise, the CPU 601 implements functionality as the difference extraction module 232 by reading the difference extraction module program 632 from the secondary storage 603, loading the program into the main storage 602, and executing the program. The CPU 601 also implements functionality as the scheduler module 233 by reading the scheduler module program 633 from the secondary storage 603, loading the program into the main storage 602, and executing the program.

As described previously, according to the first embodiment, the data transfer device 203 fetches all records of current data specified as a target of synchronization from the source device that is the source of synchronization and stores them into the current data repository 234. The data transfer device 203 compares the current data with previous data prestored in the previous data repository 235, thereby identifying difference and makes the identified difference reflected in the data on the sink device 104, followed by updating the previous data to the current data.

The sink device 104 is, for example, a relational database. The current data repository 234 and the previous data repository 235 on the transfer device 203 are, for example, simple and economical storage devices. In general, writing to a relational database is slower than writing to storage. Therefore, storing all records of current data fetched from the source device 102 into the current data repository 234, as done in the first embodiment, can greatly shorten the amount of time when the source device 102 is engaged in synchronization processing than writing all records of current data to the sink device 104.

Besides, the data transfer device 203 retains the same data as data that is now retained on the sink device 104 and the data transfer device 203 takes on the task of identifying difference; this can reduce the load of the sink device 104.

Note that the configuration of the first embodiment requires that both the current data repository 234 and the previous data repository 235 have a capacity that is as much as synchronization target data. The current data repository 234 and the previous data repository 235 do not have to be provided in a single storage unit; one or more storage devices may provide for the required capacity.

In the case illustrated in the first embodiment, after identified difference is reflected in the data on the sink device 104, the current data stored in the current data repository 234 is written to the previous data repository 235 as new previous data; the present invention is, however, not so limited. For instance, two data repositories may be managed by assigning each of them a flag indicating which of “current data” and “previous data”. In this case, after identified difference is reflected in the data on the sink device 104, the current data can be replaced by new previous data only by flag changeover.

### Second Embodiment

In a second embodiment, previous data that is stored in the previous data repository 235 is hash values generated per row in table data (a target table) that is now retained on the sink device 104. Taking hash values as previous data so can greatly reduce the capacity required to store previous data.

The second embodiment is described below with the focus on difference from the first embodiment.

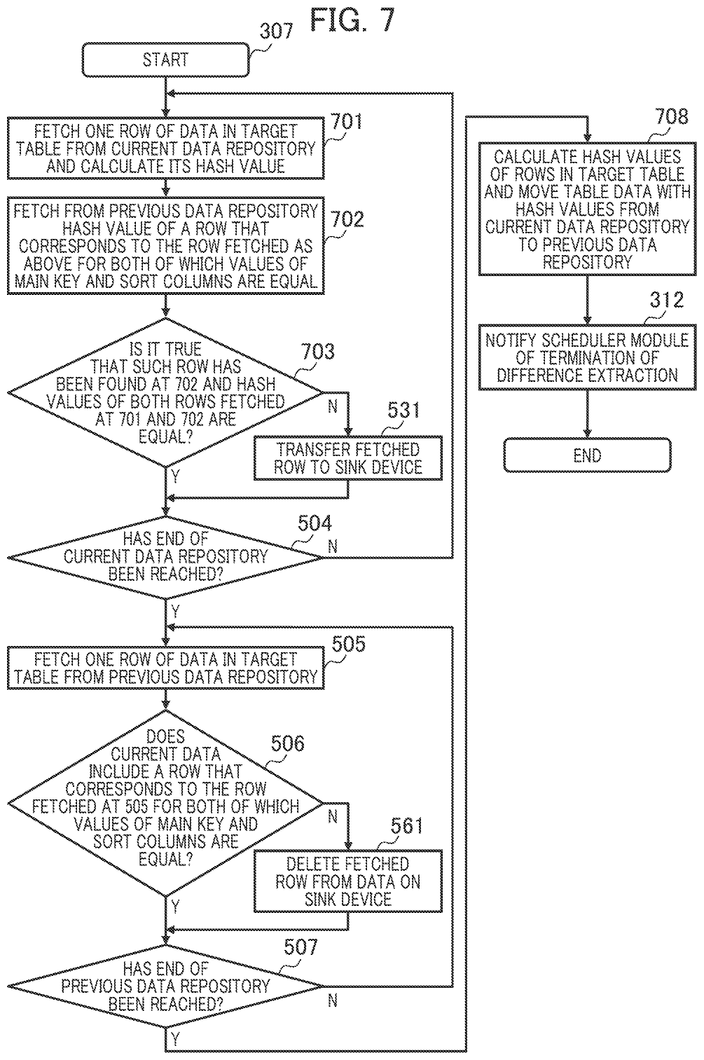

FIG. 7 is a flowchart illustrating a processing procedure of the process of extracting difference 307 in the second embodiment. Upon starting the process of extracting difference 307, the difference extraction module 232 in the second embodiment fetches one row in the target table from the current data repository 234 and calculates its hash value (701). After that, the difference extraction module 232 fetches from the previous data repository 235 the hash value of a row that corresponds to the row fetched as above for both of which the values of main key and sort columns are equal (702).

If a row that corresponds to the row fetched at 701 for both of which the values of main key and sort columns are equal is found at step 702 of the processing and the hash values of the row fetched at 701 and the row fetched at 702 are equal (703; Y), the difference extraction module 232 goes to a step 504 of the processing.

If a row that corresponds to the row fetched at 701 for both of which the values of main key and sort columns are equal is not found at step 702 of the processing and the hash values of the row fetched at 701 and the row fetched at 702 are not equal (703; N), the difference extraction module 232 transfers the row fetched at 701 to the sink device 104 (531) and then goes to the step 504 of the processing.

At the processing step 504, the difference extraction module 232 decides whether or not the end of the current data repository has been reached, i.e., whether or not all rows have now been fetched from the current data. If there remains at least an unfetched row (504; N), the difference extraction module 232 returns to the step 701 of the processing. If all rows have now been finished (504; Y), the difference extraction module 232 goes to a step 505 of the processing.

At the processing step 505, the difference extraction module 232 fetches one row in the target table from the previous data repository 235. After that, the difference extraction module 232 decides whether or not the current data includes a row that corresponds to the row fetched as above for both of which the values of main key and sort columns are equal (506).

At the processing step 506, if the current data includes a row that corresponds to the row fetched as above for both of which the values of main key and sort columns are equal, the difference extraction module 232 goes to a step 507 of the processing.

At the processing step 506, if the current data does not include a row that corresponds to the row fetched as above for both of which the values of main key and sort columns are equal, the difference extraction module 232 deletes the row fetched at 505 from the data on the sink device 104 (561) and then goes to the step 507 of the processing.

At the processing step 507, the difference extraction module 232 decides whether or not the end of the previous data repository has been reached, i.e., whether or not all rows have now been fetched from the previous data. If there remains at least an unfetched row (507; N), the difference extraction module 232 returns to the step 505 of the processing. If all rows have now been finished (507; Y), the difference extraction module 232 goes to a step 708 of the processing.

At the processing step 708, the difference extraction module 232 reads the current data from the current data repository 234, calculates hash values of all rows, and storing the data with the hash values into the previous data repository 235, thereby moving the target table. After that, the difference extraction module 232 notifies the scheduler module 233 of the termination of difference extraction (312) and terminates the process of extracting difference 307.

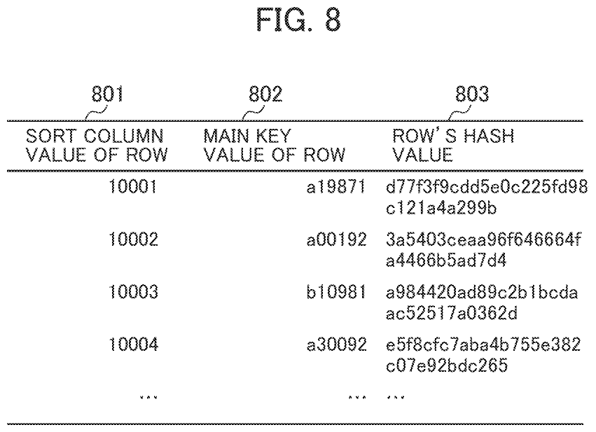

FIG. 8 is a diagram to explain previous data in the second embodiment. The previous data in the second embodiment is a table having the columns of sort column value of row 801, main key value of row 802, and row's hash value 803. The main key value of row 802 is a unique value that can uniquely identify a row in the target table. The sort column value of row 801 is the value of a particular row specified among rows contained in the target table. The row's hash value is that calculated for each of rows in the target table.

A combination of the sort column value of row 801 and the main key value of row 802 is used to identify corresponding rows between the current data and the previous data. The row's hash value is used to make a decision as to whether or not the values of all columns for the rows identified as the corresponding ones match completely.

In the second embodiment, previous data is hash values generated from data that is now retained on the sink device 104 and, after reflecting difference in the data on the sink device 104, the difference extraction module 232 gets and preserves hash values generated from the current data as previous data. Therefore, previous data size can be reduced in addition to the same effects as with the first embodiment.

Note that, in the illustrated configuration of the second embodiment, after reflecting identified difference in the data on the sink device 104, hash values are calculated from the current data. In this case, the previous data capacity can be compressed immediately after the reflection. Especially when multiple data tables are managed, an effect can be obtained in which the capacity can be reduced so much as the number of the data tables.

As a modification to the second embodiment, it may be carried out to preserve previous data unhashed until input of new current data and hash the previous data immediately before acquisition of new current data. In this case, it is possible to response to even a change to sort columns differently from last-time synchronization. Especially when a single data table is managed, there is no disadvantage of increase in storage capacity to be provided.

### Third Embodiment

In a third embodiment, chunks, each containing one or more rows, are set for a target data table. By generating one hash value from one or more rows contained in a chunk and getting chunk hash values as previous data, the previous data size is more reduced than managing hash values on a per-row basis.

A chunk is set by specifying a range of values (maximum and minimum values) of sort column in the data table and each chunk is identified by assigning it a chunk number.

The third embodiment is described below with the focus on difference from the second embodiment.

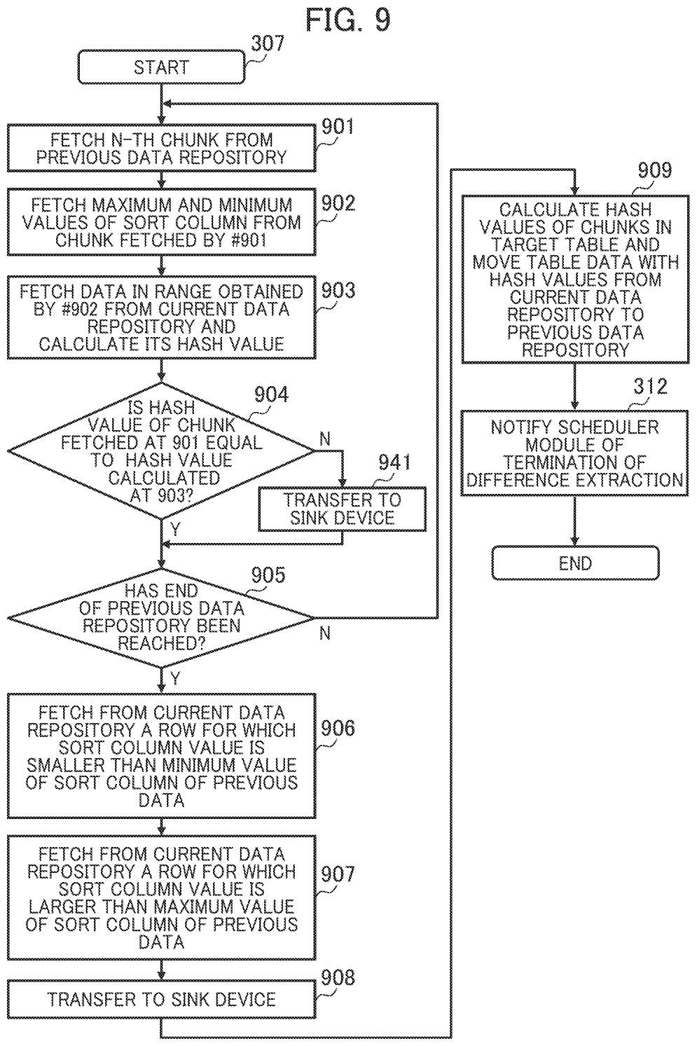

FIG. 9 is a flowchart illustrating a processing procedure of the process of extracting difference 307 in the third embodiment. Upon starting the process of extracting difference 307, the difference extraction module 232 in the third embodiment fetches an n-th chunk from the previous data repository 235 (901) and fetches the maximum and minimum values of sort column for the fetched chunk (902).

After that, the difference extraction module 232 fetches data in a range obtained by step 902 of the processing from the current data repository 234 and calculates its hash value (903).

The difference extraction module 232 compares the hash value of the chunk fetched at 901 and the hash value calculated at step 903 of the processing (904).

As a result of the comparison, if the hash values match (904; Y), the module goes to a step 905 of the processing.

If the hash values do not match (904; N), the difference extraction module 232 transfers all rows contained in the chunk to the sink device 104 (941) to make reflection of create, update, or delete that occurred in the chunk and goes to a step 905 of the processing.

At the processing step 905, the difference extraction module 232 decides whether or not the end of the previous data repository has been reached, i.e., whether or not all chunks have now been fetched from the previous data. If there remains at least an unfetched chunk (905; N), the difference extraction module 232 returns to the step 901 of the processing. If all chunks have now been fetched (905; Y), the difference extraction module 232 goes to a step 906 of the processing.

At the processing step 906, the difference extraction module 232 fetches from the current data repository 234 a row for which the sort column value is smaller than the minimum value of sort column of previous data. At a processing step 907 that follows, the difference extraction module 232 fetches from the current data repository 234 a row for which the sort column value is larger than the maximum value of sort column of previous data.

The difference extraction module 232 transfers rows fetched at the processing steps 906 and 907 to the sink device 104 (908). The thus transferred rows that have been created beyond the range of previous data are reflected in the data on the sink device 104.

Following the processing step 908, the difference extraction module 232 calculates hash values of the chunks in the target table with the current data in the current data repository 234 and stores the table data with the hash values into the previous data repository 235, thereby updating the previous data (909). After that, the difference extraction module 232 notifies the scheduler module 233 of the termination of difference extraction (312) and terminates the process of extracting difference 307.

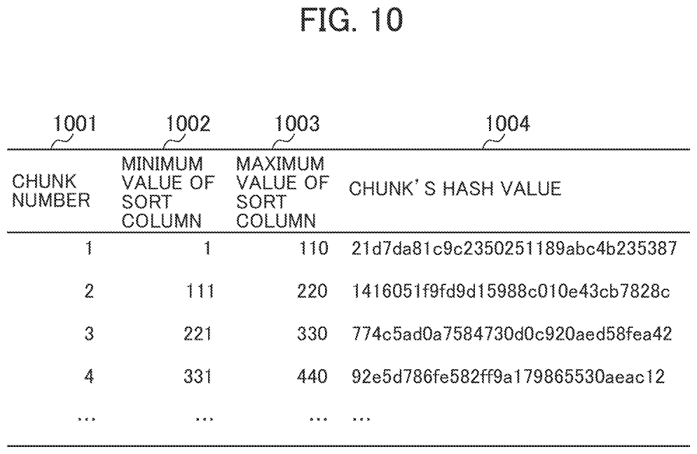

FIG. 10 is diagram to explain previous data in the third embodiment. The previous data in the third embodiment has the columns of chunk number 1001, minimum value of sort column 1002, maximum value of sort column 1003, and chunk's hash value 1004. Specifically, a chunk with chunk number “1” contains rows having sort column values from “1” to “100” and one hash value is calculated from all rows contained in the chunk. Likewise, a chunk with chunk number “2” contains rows having sort column values from “111” to “220” and one hash value is calculated from all rows contained in the chunk.

Because chunks are set by a range of sort column values, the number of rows contained in each chunk does not need to be the same. Additionally, row insertion or deletion even when occurring in a chunk does not influence other chunks.

In the third embodiment, the difference extraction module 232 sets one or more chunks for table data that is now retained on the sink device, generates one hash value from one or more rows contained in each one of the chunks, and gets and preserves chunk hash values as previous data. Therefore, previous data size can be reduced in addition to the same effects as with the first embodiment.

Besides, the difference extraction module 232 sets a chunk by specifying a range of values of a fixed column in table data; consequently, it can be avoided that creating or deleting a row influences other chunks and difference can efficiently be reflected in units of chunks.

### Fourth Embodiment

A fourth embodiment sets forth a configuration for updating chunk size dynamically.

The fourth embodiment is described below with the focus on difference from the third embodiment.

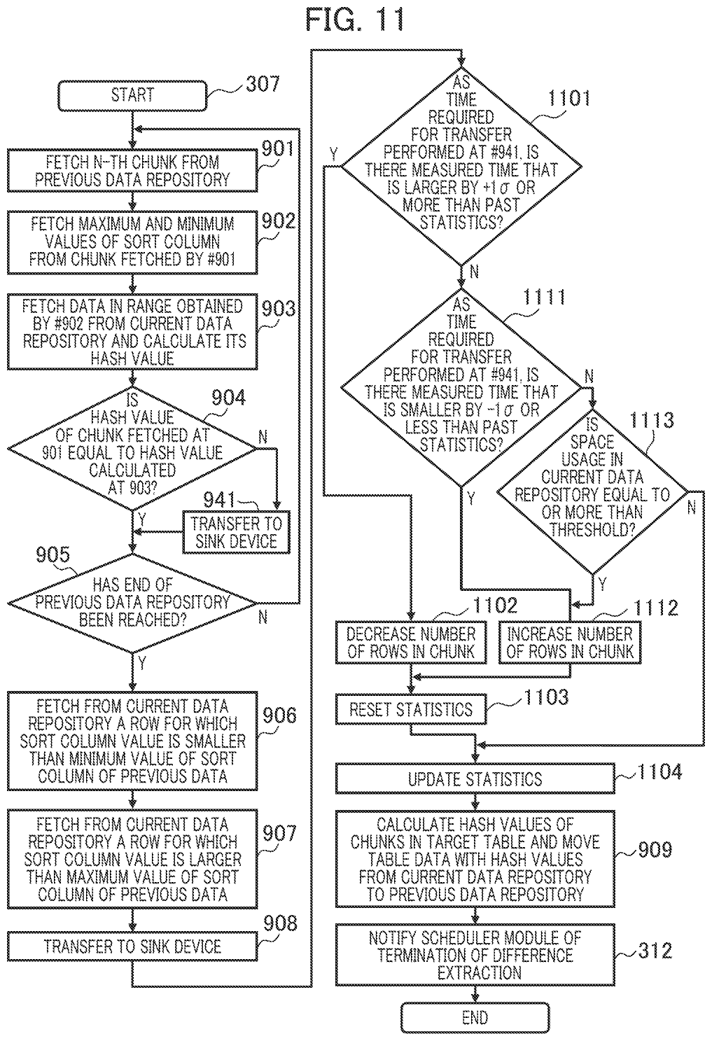

FIG. 11 is a flowchart illustrating a processing procedure of the process of extracting difference 307 in the fourth embodiment. Steps 901 to 908 of the processing are the same as for the third embodiment and, therefore, description thereof is omitted.

In the fourth embodiment, after the processing step 908, a transition is made to a step 1101.

At the processing step 1101, the difference extraction module 232 decides whether or not, as time required for the transfer performed at the processing step 941, there is a measured time that is larger by +1σ or more than past statistics.

If there is a measured time that is larger by +1σ or more than past statistics as the required time (1101; Y), the module goes to a step 1102.

If there is not a measured time that is larger by +1σ or more than past statistics as the required time (1101; N), the difference extraction module 232 decides whether or not, as time required for the transfer performed at the processing step 941, there is a measured time that is smaller by −1σ or less than past statistics (1111).

If there is a measured time that is smaller by −1σ or less than past statistics as the required time (1111; Y), the module goes to a step 1112.

If there is not a measured time that is smaller by −1σ or less than past statistics as the required time (1111; N), the difference extraction module 232 decides whether or not space usage in the current data repository 234 is equal to or more than a threshold (1113).

If space usage in the current data repository 234 is equal to or more than the threshold (1113; Y), the module goes to a step 1112 of the processing; if space usage in the current data repository 234 is less than the threshold (1113; N), the module goes to a step 1104.

At the processing step 1102, the difference extraction module 232 changes the range of a chunk to decrease the number of rows contained in the chunk and goes to a step 1103 of the processing.

At the processing step 1112, the difference extraction module 232 changes the range of a chunk to increase the number of rows contained in the chunk and goes to the step 1103 of the processing.

As an example, when increasing the number of rows of a chunk, the module increases the chunk range by 25%; when decreasing the number of rows of a chunk, the module decreases the chunk range by 25%.

At the processing step 1103, the module resets the value of statistics on the time required for the transfer and goes to a step 1104.

At the processing step 1104, the difference extraction module 232 updates the statistics with the time required for the transfer performed at 941 this time.

Following the processing step 1104, the difference extraction module 232 calculates hash values of the chunks in the target table with the current data in the current data repository 234 and stores the table data with the hash values into the previous data repository 235, thereby updating the previous data (909). After that, the difference extraction module 232 notifies the scheduler module 233 of the termination of difference extraction (312) and terminates the process of extracting difference.

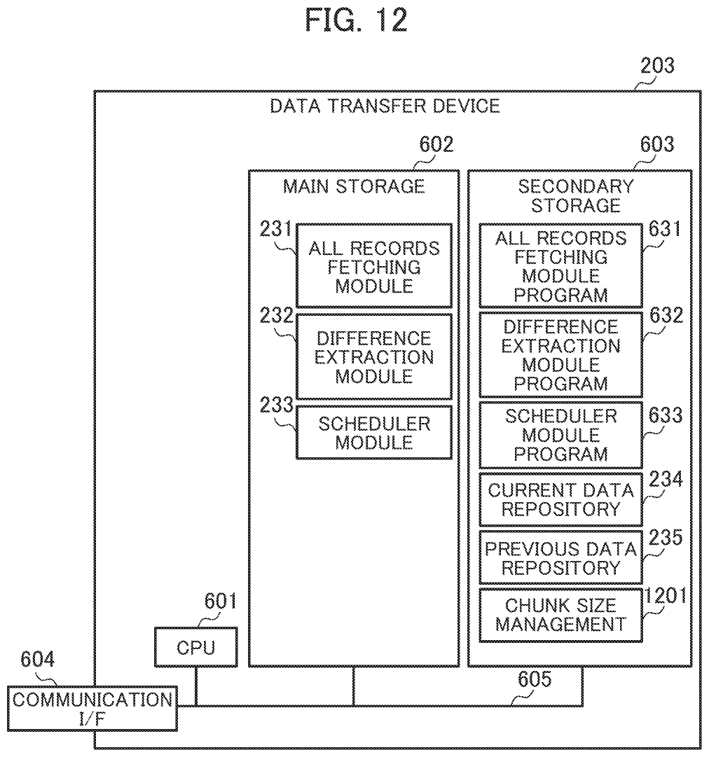

FIG. 12 is a structural diagram of the data transfer device 203 in the fourth embodiment. As is depicted in FIG. 12, the secondary storage 603 in the fourth embodiment further retains data on chunk size management 1201. With this data, the data transfer device 203 manages chunk size.

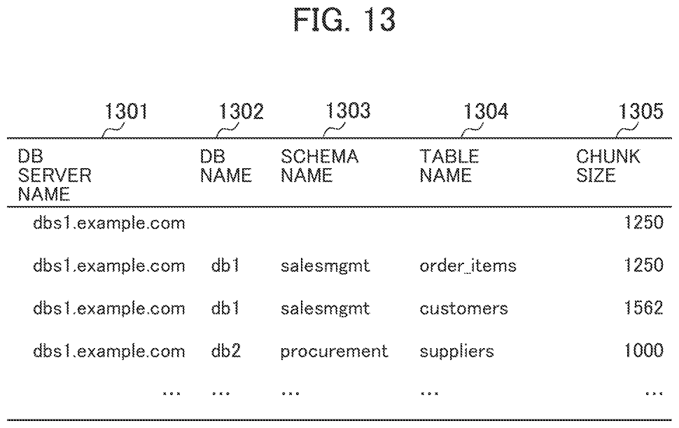

FIG. 13 is a diagram to explain chunk size management. As is illustrated in FIG. 13, chunk size management is performed by associating chunk size with information identifying a table (DB server name 1301, DB name 1302, schema name 1303, and table name 1304). Chunk size corresponds to a range of sort column values of each chunk.

In the fourth embodiment, the difference extraction module 232 is able to update chunk size depending on the load status of the sink device 104 and/or free space of the current data repository 234. Note that, although time required for transfer is used to indicate the load status of the sink device 104 in the case illustrated in the fourth embodiment, chunk size can be updated using any given data indicating the load of the sink device 104. Likewise, by using any given data indicating the load of the sink device 104 not limited to free space of the current data repository 234, chunk size can be updated. Furthermore, chunk size can be updated through the use of the status of the source device 102 and the network status among others.

### Fifth Embodiment

While all rows of table data fall in any of chunks in the case illustrated in the fourth embodiment, a part of table data may be excluded from a range of chunks to be set.

For example, suppose that the object to synchronize is sales management data. New sales data is created serially and the frequency of occurrence of update or delete would be lower than the frequency of occurrence of create. Changing or deleting new sales records occupies the majority of occurrences of update or delete and changing or deleting old sales records is less likely to occur.

For a table having characteristics as above, it is preferable to set a sales date column as the sort column, exclude a certain range of rows of newer date records from a range of chunks to be set, and identify difference on a per-row basis for the predetermined range of rows, so that data synchronization can be performed efficiently.

The fifth embodiment sets forth a configuration for excluding a certain range of rows of table data for which create is anticipated from a range of chunks to be set and identifying difference on a per-row basis in the predetermined range.

The fifth embodiment is described below with the focus on difference from the fourth embodiment.

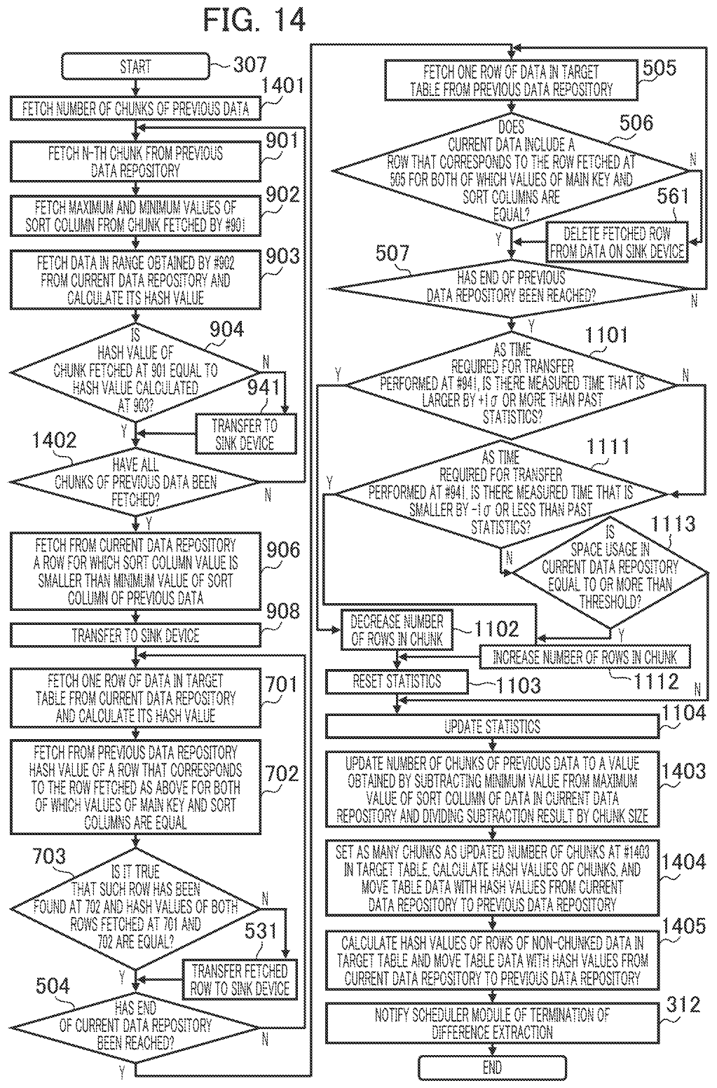

FIG. 14 is a flowchart illustrating a processing procedure of the process of extracting difference 307 in the fifth embodiment. Upon starting the process of extracting difference 307, the difference extraction module 232 in the fifth embodiment fetches the number of chunks of previous data (1401). The number of chunks of previous data is the number of chunks set for the previous data and included in data on chunk size management 1201 in the fifth embodiment.

Following the processing step 1401, the difference extraction module 232 executes steps 901 to 904 and step 941 of the processing as with the fourth embodiment.

In the fifth embodiment, as a result of comparison at 904, if the hash values match (904; Y) or upon termination of the step 941 of the processing, a transition is made to a step 1402 of the processing.

At the processing step 1402, the difference extraction module 232 decides whether or not all chunks of previous data have now been fetched.

If there remains at least an unfetched chunk (1402; N), the difference extraction module 232 returns to the step 901 of the processing. If all chunks have now been fetched (1402; Y), the difference extraction module 232 proceeds to a step 906 of the processing.

At the processing step 906, the difference extraction module 232 fetches from the current data repository 234 a row for which the sort column value is smaller than the minimum value of sort column of previous data, as is the case for the third embodiment. After that, the module proceeds to a step 908 of the processing, skipping the processing step 907 which has been illustrated for the third embodiment.

At the processing step 908, the difference extraction module 232 transfers rows fetched at the processing step 906 to the sink device 104 (908). The thus transferred rows that have smaller sort column values than the range of previous data are reflected in data on the sink device 104.

After the processing step 908, the difference extraction module 232 proceeds to a step 701 of the processing. Steps 701 to 703, step 531, steps 504 to 507, and step 561 of the processing are the same as for the second embodiment.

If, at the processing step 507, the end of the previous data repository has been reached (507; Y), the difference extraction module 232 goes to a step 1101 of the processing. Steps 1101 to 1104 of the processing are the same as for the fourth embodiment.

Following the processing step 1104, the difference extraction module 232 updates the number of chunks of previous data to a value obtained as below: subtracting the minimum value from the maximum value of sort column of data in the current data repository, dividing the subtraction result by chunk size, assigning the resultant quotient to the new number of chunks (1403).

Following the processing step 1403, for the target table in the current data repository 234, the difference extraction module 232 sets as many chunks as the number of chunks obtained at the processing step 1403 in ascending order of the sort column value, calculates hash values of all chunks, and moves the table data with the hash values to the previous data repository 235 (1404).

Following the processing step 1404, the difference extraction module 232 calculates hash values for each of rows that are excluded from the range of the set chunks, that is, the rows of non-chunked data having larger values of sort column and moves the table data with the hash values to the previous data repository 235 (1405).

After the processing step 1402, the difference extraction module 232 notifies the scheduler module 233 of the termination of difference extraction (312) and terminates the process of extracting difference.

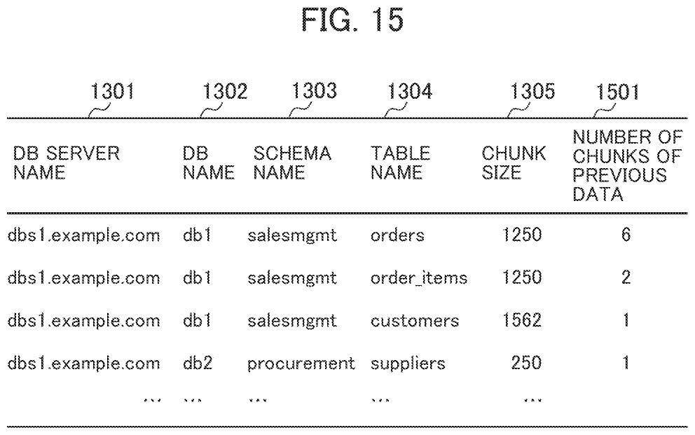

FIG. 15 is a diagram to explain chunk size management in the fifth embodiment. As is illustrated in FIG. 15, chunk size management in the fifth embodiment is performed by associating chunk size and the number of chunks of previous data with information identifying a table (DB server name 1301, DB name 1302, schema name 1303, and table name 1304). Chunk size corresponds to a range of sort column values of each chunk and the number of chunks corresponds to the number of chunks set for previous data.

In the fifth embodiment, the difference extraction module 232 excludes a certain range of rows of table data for which create is anticipated from the range of set chunks and identifies difference on a per-row basis in the predetermined range. Therefore, it is possible to efficiently perform data synchronization for a data table having characteristics in which occurrence of creating, updating, or deleting data is concentrated in a certain range.

Note that, in the case illustrated in the fifth embodiment, after subtracting the minimum value from the maximum value of sort column of data in the current data repository, the subtraction result is divided by chunk size and the division remainder is taken as a certain range; however, it is possible to set a certain range in an optional manner. For instance, if the division remainder is zero, the number of chunks may be decremented by one. Alternatively, the following manner may be adopted: in addition to subtracting the minimum value from the maximum value of sort column of data in the current data repository, further subtract a guaranteed minimum number of rows in a certain range and then divide the subtraction result by chunk size.

### Modification Example

The foregoing first through fifth embodiments are only exemplary and are not intended to limit the present invention. For example, the data transfer device 203 is not necessarily configured as an integral device. Multiple devices may cooperate to implement functionality of the data transfer device 203.

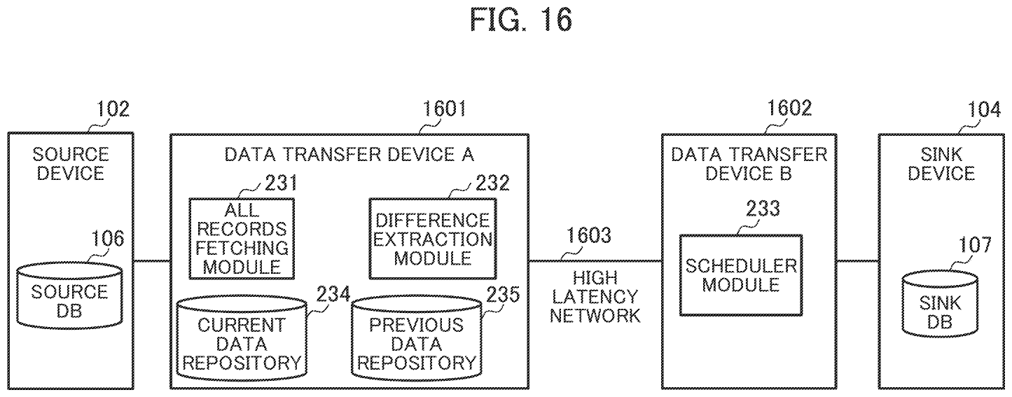

FIG. 16 is a configuration example where multiple devices are used to cooperate to implement functionality of the data transfer device. A system of FIG. 16 is provided with a data transfer device A 1601 as a source side transfer device that connects to and communicates with the source device 102 and a data transfer device B 1602 as a sink side transfer device that connects to and communicate with the sink device 104.

Besides, the data transfer device A 1601 and the data transfer device B 1602 are connected by a high latency network 1603. The data transfer device A 1601 includes the all records fetching module 231, the difference extraction module 232, the current data repository 234, and the previous data repository 235 and the data transfer device B 1602 includes the scheduler module 233.

In this configuration, it is possible to shorten the amount of time when the synchronization source device is engaged in data synchronization processing and reduce the load of the sink device 104 even with the intervention of the high latency network. It is also possible to decrease data that the data transfer device A 1601 outputs to the network.

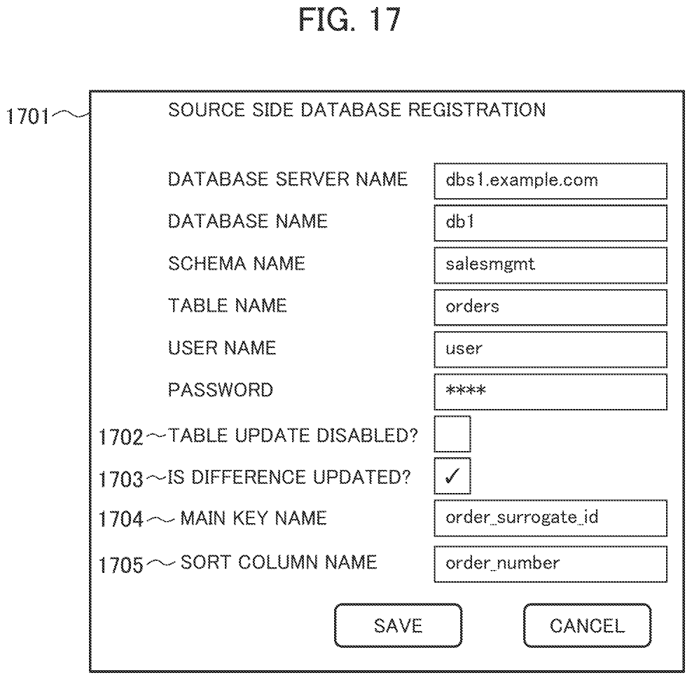

FIG. 17 is a concrete example of a synchronization setup screen. The setup screen 1701 illustrated in FIG. 17 includes the entry fields of update setting 1702, difference update setting, 1703, the name of main key column header 1704, and the name of sort column header 1705 in addition to the entry fields related to a database and a user.

The update setting 1702 field is provided to specify whether or not updating (rewiring) existing data of a table is enabled. The difference update setting 1703 field is provided to specify whether or not to update difference when synchronization is performed.

Here, in FIG. 17, the update setting 1702 enables updating existing data and it is set to update difference. In related art, it is allowed to choose difference update, provided that it is disabled to update existing data. In contrast, in the system disclosed in the embodiments herein, it is possible to update difference for data even in a table for which it is enabled to update existing data, since the data transfer device 203 fetches all records of current data and identifies difference.

The main key name 1704 and the sort column name 1705 are the fields for setting which column is to be used to identify correspondence relationship between previous data and current data when difference update is performed.

The foregoing first through fifth embodiments and the modification example are not intended to limit the present invention and various modifications are included in the invention. For instance, the foregoing embodiments and the like are those described in detail to explain the present invention clearly and the invention is not necessarily limited to those including all components described. Furthermore, some of such components may be deleted and, besides, may be replaced by other components or other components may be added.

What is claimed is:

1. A data synchronization system comprising:
an all records fetching unit that fetches all records of synchronization target data, i.e., data specified as a target of synchronization, from a first device that is a source of synchronization;
one or more storage units to prestore synchronization destination data, namely, data that is now retained on a second device that is a destination of synchronization and store synchronization target data fetched by the all records fetching unit; and
a difference extraction unit that identifies difference to be reflected in the data on the second device by using the synchronization destination data and the synchronization target data, makes identified difference reflected in the data on the second device, and, after the reflection, updates the synchronization destination data based on the synchronization target data.

2. The data synchronization system according to claim 1, wherein the synchronization destination data is hash values generated from data that is now retained on the second device and the difference extraction unit, after making the difference reflected in the data on the second device, gets and preserves hash values generated from the synchronization target data as new synchronization destination data.

3. The data synchronization system according to claim 2, wherein the difference extraction unit sets one or more chunks for table data that is now retained on the second device, generates one hash value from one or more rows contained in each one of the chunks, and gets and preserves chunk hash values as previous data.

4. The data synchronization system according to claim 3, wherein the difference extraction unit sets the chunks by specifying a range of values of a fixed column in the table data.

5. The data synchronization system according to claim 4, wherein the difference extraction unit excludes a certain range of rows of the table data for which create is anticipated from a range of the chunks to be set and identifies difference on a per-row basis in the predetermined range.

6. The data synchronization system according to claim 3, wherein the difference extraction unit updates chunk size of the chunks depending on load status of the second device.

7. The data synchronization system according to claim 3, wherein the difference extraction unit updates chunk size of the chunks depending on free space in the one or more storage units.

8. The data synchronization system according to claim 2, wherein the synchronization destination data is hash values generated for each row of table data that is now retained on the second device.

9. The data synchronization system according to claim 1, wherein the synchronization destination data is identical to data that is now retained on the second device.

10. The data synchronization system according to claim 1, comprising:
a source side transfer device that connects to and communicates with the first device and a sink side transfer device that connects to and communicates with the second device,
wherein:
the source side transfer device comprises at least the all records fetching unit and the one or more storage units; and
the sink side transfer device is connected with the source side transfer device via a certain network and executes a process of reflecting the difference in the data on the second device.

11. A data synchronization apparatus comprising:
an all records fetching unit that fetches all records of synchronization target data, i.e., data specified as a target of synchronization, from a first device that is a source of synchronization;
one or more storage units to prestore synchronization destination data, namely, data that is now retained on a second device that is a destination of synchronization and store synchronization target data fetched by the all records fetching unit; and
a difference extraction unit that identifies difference to be reflected in the data on the second device by using the synchronization destination data and the synchronization target data, makes identified difference reflected in the data on the second device, and, after the reflection, updates the synchronization destination data based on the synchronization target data.

12. A data synchronization method comprising the steps of:
fetching all records of synchronization target data, i.e., data specified as a target of synchronization, from a first device that is a source of synchronization;
storing synchronization target data fetched by the step of fetching all records into a certain storage unit;
by using synchronization destination data, namely, data that is now retained on a second device that is a destination of synchronization and the synchronization target data, identifying difference to be reflected in the data on the second device;
making identified difference reflected in the data on the second device; and
after the reflection, updating the synchronization destination data based on the synchronization target data.
